(19) United States
(12) Patent Application Publication
(10) Pub. No.: US 2002/0067424 A1
(43) Pub. Date: Jun. 6, 2002

(54) Environmentally sealed cameras for mounting externally on aircraft and systems for using the same

(76) Inventor: Joseph F. Brunner JR., Huntington Beach, CA (US)

Correspondence Address: Eric K. Satermo, Registered Patent Agent, P.O. Box 19099, Irvine, CA, 92623-9099, US

(21) Appl. No.: 09/728,772

(22) Filed: Dec. 1, 2000

(51) Int. Cl. H04N 5/225

(52) U.S. Cl. 348/373; 348/144

(57) ABSTRACT

An aircraft-mounted camera system includes a camera and a housing that conforms to the topography of an aircraft. A camera is attached to a small window that includes a conductive-film heating element. The camera and window are seated within the housing receptacle, and held in place by an epoxy filler that also serves to insulate the camera from vibration. The camera system is attached to the outer body of the aircraft using a backing plate. The aircraft-mounted camera system may be easily manufactured at low cost, and can serve several functions, including pilot aircraft observation and passenger entertainment when connected to an in-cabin display.

### FIELD OF THE INVENTION

The present invention relates to video cameras and, more particularly, to video cameras that are sealed to the environment. The cameras of the present invention are particularly beneficial when mounted to the surface of an aircraft where the cameras are subject to a harsh environment. The present invention also relates to methods for manufacturing such cameras and systems for their use.

### BACKGROUND OF THE INVENTION

Aircraft-mounted camera systems have several uses. For example, they may be used to provide in-flight entertainment to cabin passengers. Cabin passengers may want to see the same view as their pilot, but are prohibited because cabin windows are small, views are often obstructed by aircraft structures, and access to cabin windows is often restricted by seating configurations. Cabin passengers may realize a more enjoyable flight by watching a display screen that projects an unobstructed, wide-angle forward view of the flight path. Other uses of aircraft-mounted camera systems include safety, security, and surveillance.

Mounting a camera on the outside surface of an aircraft presents several environmental challenges. One of these challenges is temperature extremes. Environmental temperature generally drops as altitude increases. At high altitudes, temperatures may become extremely cold. Camera mounting systems must be designed to prevent fogging and crystallization of vapor on the camera lens or window as a result of temperature change.

Another challenge is vibration. Vibration may be caused by aircraft propulsion systems, turbulence, or the friction and drag forces exerted by high-speed travel. Camera mounting systems must be designed to prevent the camera from being exposed to excessive vibrations that could impair image quality. The mounting system must also be aerodynamic, and seamlessly integrate with the aircraft body in order to maintain aircraft performance and minimize drag.

Camera mounting apparatus found in the prior art tend to be complex and involve numerous moving parts. As a result, they contain expensive components and require complex and, therefore, expensive manufacturing methods.

Accordingly, there is a need for cameras that are able to withstand extreme environmental conditions and for simple, low-cost, aerodynamic mounting apparatus that resists vibration and provides a low-cost heating mechanism to prevent environmental impairment of the camera view at extreme temperatures.

### SUMMARY OF THE INVENTION

In a preferred embodiment, the invention provides a simple, low-cost, aerodynamic camera system. A mounting apparatus that cushions a camera with a surrounding vibration-dampening layer of epoxy. The invention incorporates an efficient, low-cost heater that heats the camera window directly rather than heating the entire apparatus. The aircraft-mounted camera system of the invention is easy to manufacture, easy to install, is mechanically simple, and can be manufactured without the need for elaborate and expensive manufacturing equipment.

A camera system according to the preferred embodiment of the invention includes a camera and a housing. The housing conforms to the topography of the aircraft and includes a receptacle with an opening. A window made of a material such as sapphire is included, with a heating element such as a conductive film disposed on the window. The camera is mounted within the receptacle and is attached to the window with an adhesive compound such as epoxy. The camera is held within the receptacle and insulated from vibration by a filler such as epoxy. An end plate holds the camera in place, and a backing plate attaches the entire assembly to the aircraft body.

The camera system of the present invention has many advantages. For example, a pilot may observe the aircraft from the cockpit, such as gear down, blown tires, hot brakes, runway/taxiway alignment, flaps, slats, flight controls, thrust reversers, and so on. In addition, passengers may observe exterior view during flight.

Other aspects, features, and advantages of the present invention will become apparent to those persons having ordinary skill in the art to which the present invention pertains from the following description taken in conjunction with the accompanying drawings.

### BRIEF DESCRIPTION OF THE DRAWINGS

FIG. 1 is a perspective view of an aircraft fitted with a surface-mounted camera of the invention;

FIG. 1a is a fragmentary cross-sectional view of a section of an aircraft, particularly illustrating a topography thereof;

FIG. 2 is an exploded view of an aircraft-mountable camera of the invention;

FIG. 2a is a fragmentary perspective view of a camera of the present invention, particularly illustrating a lens arrangement of the camera;

FIG. 3 is a perspective view of the camera of FIG. 2 as assembled;

FIG. 4 is a cross-sectional view of a preferred embodiment of an aircraft camera of the invention, particularly illustrating an epoxy-embedded camera within a housing;

FIG. 4a is a schematic view of a window heater configured in accordance with the invention; and

FIG. 5 is a flowchart illustrating a method for manufacturing a camera in accordance with the invention.

### DETAILED DESCRIPTION OF THE INVENTION

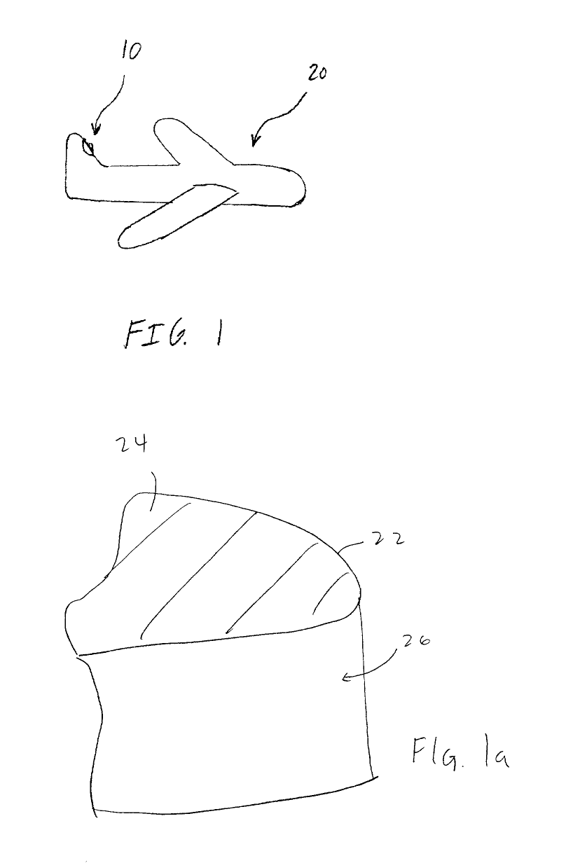

Referring to the drawings in more detail, FIG. 1 is an exemplary illustration of a camera system 10 of the present invention mounted at the tail-section of an aircraft 20. The aircraft may be any type of solid-body aircraft, including for example a jet, propeller plane or a helicopter. Although the camera system 10 may be mounted in nearly any location along the topography of the aircraft 20, the camera system 10 is shown mounted to a leading edge 22 of a tail section 24 of the aircraft 20. As shown in FIG. 1a, the surface of the tail section 24 at the leading edge 22 has a topography indicated by numeral 26. For the purposes of this description, the camera system 10 will be described as configured to be mounted to the tail section 24. However, those skilled in the art will appreciate that the camera system 10 may be configured to mount to other sections of the aircraft 20, for example, a wing section 27, a belly section 28, or a nose section 29.

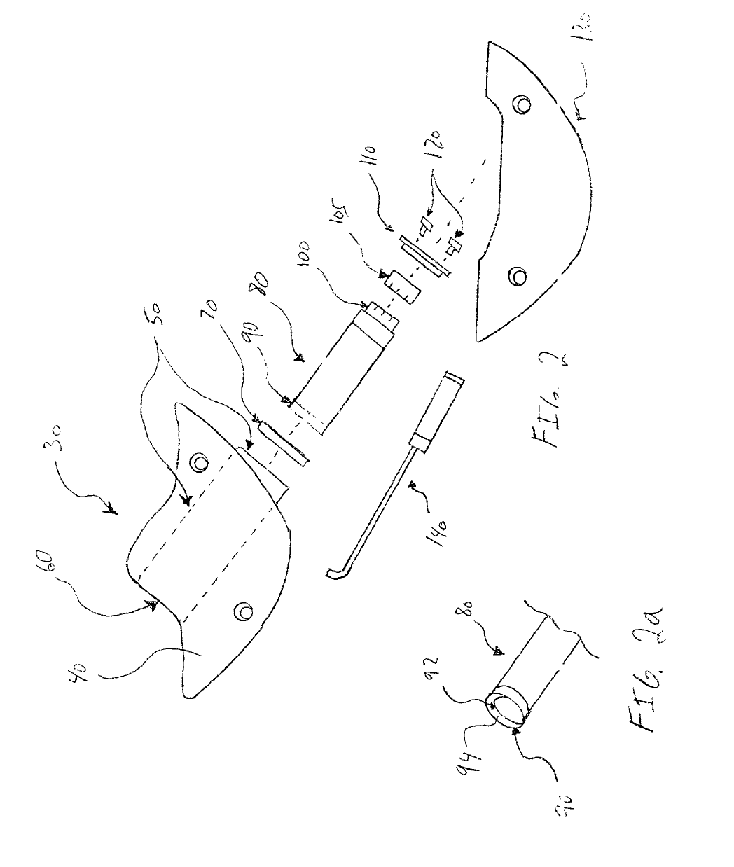

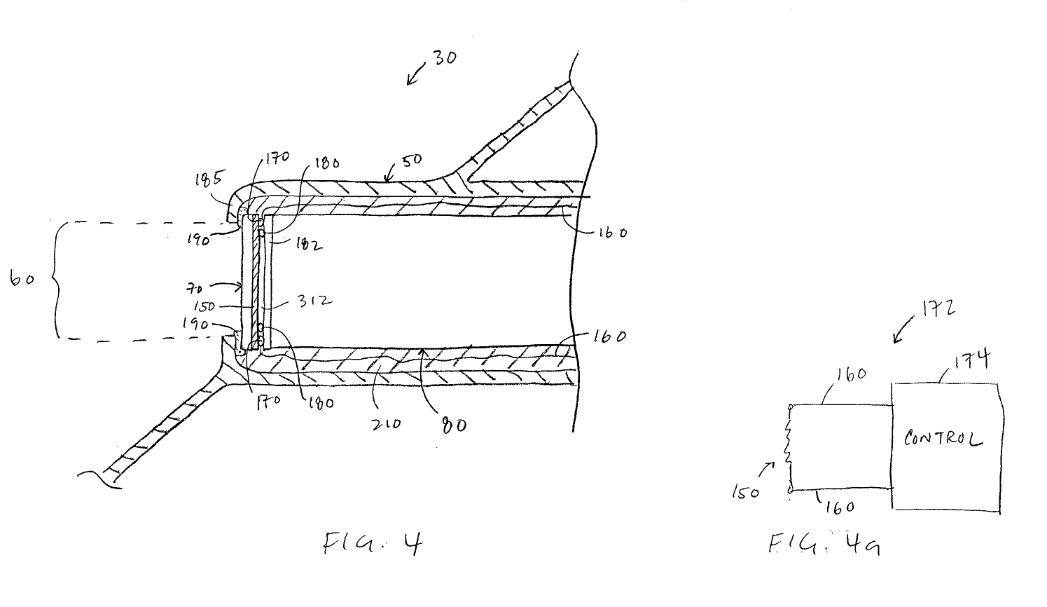

FIG. 2 is an exemplary illustration of an exploded view of a camera system 10, detailing the component parts. The housing 30 includes a flange portion 40 and a receptacle 50. The housing 30 is preferably made of a strong material capable of withstanding the environmental conditions associated with aircraft flight, such as aluminum, and may be made of any material commonly used for aircraft bodies. As shown in FIG. 4, an opening 60 is included, shown in a circular shape at the end of the receptacle 50. Opening 60 and receptacle 50 may be any shape that corresponds to the shape of camera 80. A window 70 is also shown that fits within receptacle 50 and seats within the opening 60.

As shown in FIG. 2, window 70 may be as a circular disk and may be made of any clear material know to those skilled in the art to be capable of withstanding the temperature extremes of flight, such as sapphire. Camera 80 may be any type of camera, including a still-photography camera, video camera or any other camera known by those skilled in the art. Camera 80 has a view end 90 that houses the camera lens and an output end 100 that provides connection points for the camera control systems, power supply and other electronics. Output end 100 is shown with a plug-type connection for camera electronics, with connector 105 being shown as a corresponding plug-type connection for camera electronics. However, output end 100 may employ any type of electronic connection interface known to those skilled in the art.

An exemplary end plate 110 is shown attached to the end of the receptacle 50, here shown attached with screws 120. A backing plate 130 is further shown, which holds the housing 30 in place on the aircraft 20. A heater connection for a window heater (shown in FIG. 4) is fed into the aircraft 20 through heater connector 140. As shown in FIG. 2a, the camera lens 92 is recessed from the camera view end 90, thereby defining a recess space 94 between the view end of the camera 80 and the camera lens 92., which will be discussed in more detail below.

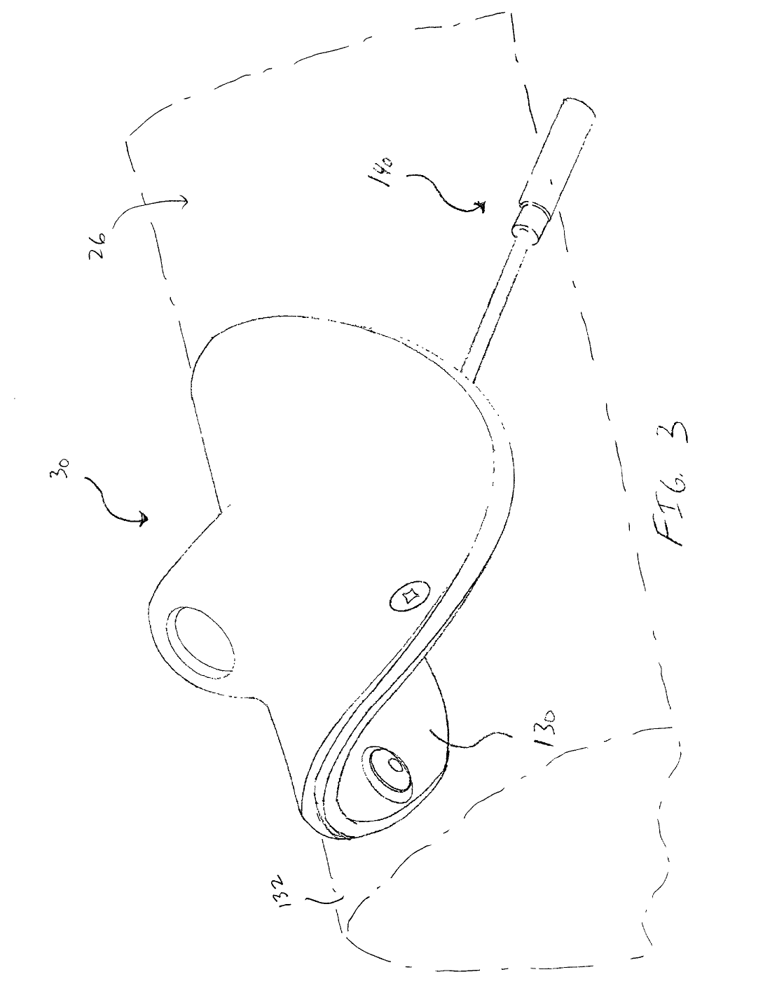

FIG. 3 is an exemplary perspective illustration of an assembled mounting apparatus for exemplary camera system 10. Housing 30 is shown attached to backing plate 130, sandwiching an aircraft skin 132 in between housing 30 and backing plate 130 and firmly attaching the entire assembly to the aircraft. Heater connector 140 is shown extending into the interior of the aircraft 20. As can be seen, housing 30 and backing plate 130 are configured to conform in shape to the topography 26 of aircraft skin 132 to provide secure attachment and fit.

FIG. 4 shows a cross-sectional view of an exemplary housing 30. Window 70 is shown with a heater, here depicted as a conductive film 150 disposed upon the interior surface of the window. Conductive film 150 may be comprised of any material that is both optically transparent and capable of transforming electrical energy into thermal energy. Heater wires 160 provide current to the conductive film 150, which translates the current into heat. Solder 170 is shown connecting the heater wires 160 to the conductive film 150. Other types of attachment may be similarly used that are known to those skilled in the art. As shown in FIG. 4a, a heater 172 of the invention includes a control circuit 174 for providing current to the conductive film 150 through wires 160. One example of a conductive film that may be utilized is indium titanium oxide (ITO).

The camera 80 may be attached to the interior surface of the window 70 by a,first portion of adhesive compound 180 such as epoxy, sandwiching the conductive film 150 between a lens 182 of the camera 80 and the window 70 of the housing 30. A second portion of adhesive compound 190, such as epoxy, may be used to loosely attach the window 70 to the interior lip 185 of the opening 60 of the receptacle 50, allowing adjustment of the camera position during assembly of the video system prior to fixing the camera firmly in place. A space 200 is defined between the camera 80 and the interior wall of the receptacle 50. This space 200 is filled with a filler 210, such as epoxy, in order to hold the camera 80 in place and insulate it from vibration. The filler 210 may be any material, know to those skilled in the art to be capable of holding the camera 80 in a fixed position.

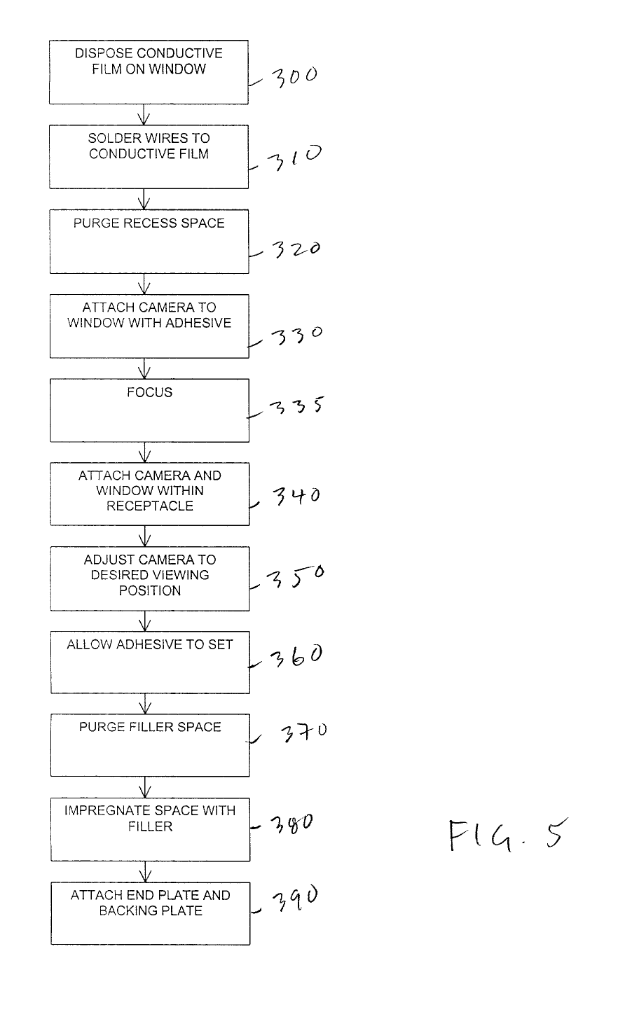

FIG. 5 is a flowchart showing an exemplary manufacturing method for the camera mounting system. The camera heating system may be fabricated by first disposing the conductive film 150 on the window 70 (step 300) and then soldering a pair of wires 160 to the conductive film 150 (step 310). The window 70 may then be attached to the camera 80. This may be accomplished by first purging a recess space between the window 70 and the lens 182 of the camera 80, which space is indicated by numeral 312 in FIG. 4, a gaseous material such as nitrogen (step 320). The window 70 is then attached to the lens 182 an adhesive compound such as epoxy (step 330). The window/lens assembly may then be focussed by aligning the window 70 and the lens 182 to be substantially parallel with each other (step 335).

The camera 80 with the window 70 attached is then loosely attached to the interior lip 185 of the opening 60 in the receptacle 50 (step 340), and the camera 80 is then adjusted until the desired viewing position is attained (step 350). The adhesive 190 is then allowed to set in order to hold the camera 80 firmly in the receptacle 50 (step 360). The space 200 between the camera 80 and the receptacle 50 is purged with, e.g., nitrogen (step 370) and impregnated with a filler 210 such as epoxy (step 380). The end plate 110 is attached to the output end of the camera 80, and a backing plate 130 is used to attach the assembly to the aircraft (step 390). Either one or both of the plates 110 and 130 may be attached to the camera 80 while the filler 210 is setting to retain the camera in the desired alignment. When the filler 210 is set, the plates 110 and 130 may be detached to connect electronics to the camera as needed, and then reattached.

Those skilled in the art will understand that the embodiments of the present invention described above exemplify the present invention and do not limit the scope of the invention to these specifically illustrated and described embodiments. The scope of the invention is determined by the terms of the appended claims and their legal equivalents, rather than by the described examples. In addition, the exemplary embodiments provide a foundation from which numerous alternatives and modifications may be made, which alternatives and modifications are also within the scope of the present invention as defined in the appended claims.

We claim:

1. A camera system for mounting to an aircraft having a topography, the camera system comprising:
a housing including a flange and a receptacle, the flange being configured to complement the topography of the aircraft, the receptacle having an opening and an inner surface;
a window fixed within the opening of the receptacle;
a camera disposed within the receptacle having optical communication with the window, a space being defined between the camera and the inner surface of the receptacle; and
a filler disposed in the space to seal the camera within the receptacle.

2. A camera system as claimed in claim 1 wherein:
the filler is an adhesive compound.

3. A camera system as claimed in claim 1 wherein:
the filler is epoxy.

4. A camera system as claimed in claim 1 further comprising:
a heater configured to heat the window

5. A camera system as claimed in claim 4 wherein the heater includes:
a conductive film disposed upon the window; and
a pair of wires connected to the conductive film.

6. A camera system as claimed in claim 1 wherein:
the window includes sapphire.

7. A camera system for external mounting to an aircraft having a topography, the camera system comprising:
a housing including a flange and a receptacle, the flange being configured to complement the topography of the aircraft, the receptacle having an opening;
a window fixed within the opening of the receptacle;
a heater configured to heat the window; and
a camera disposed within the receptacle having optical communication with the window.

8. A camera system as claimed in claim 7 wherein the heater includes:
a conductive film disposed on the window; and
a pair of wires connected to the conductive film.

9. A camera system as claimed in claim 7 wherein the window is sapphire.

10. A camera system as claimed in claim 7 wherein a space is defined between the camera and an inner surface of the receptacle;
a filler occupying the space to seal the camera within the receptacle

11. A camera system as claimed in claim 10 wherein:
the filler is an adhesive compound.

12. A camera system as claimed in claim 11 wherein the adhesive compound is epoxy.
